(19) United States
(12) Patent Application Publication
(10) Pub. No.: US 2024/0313437 A1
(43) Pub. Date: Sep. 19, 2024

(54) GROUNDING CLAMPS AND SYSTEMS AND METHODS FOR USE

(71) Applicant: Tallman Equipment Co., Columbus, IN (US)

(72) Inventors: Sean Galligar, Cary, IL (US); Servando Torress, Addison, IL (US); Ed Youngerman, St. Charles, IL (US); Andrew F. Finn, Elmhurst, IL (US)

(73) Assignee: Tallman Equipment Co., Columbus, IN (US)

(21) Appl. No.: 18/122,231

(22) Filed: Mar. 16, 2023

(51) Int. Cl. H01R 4/36

(52) U.S. Cl. CPC H01R 4/366

(57) ABSTRACT

Grounding clamps having a movable jaw driven by a threaded rod having multi-start threads which exhibit improved clamping speed. The use of multi-start threads allows for a threaded rod having a larger pitch to produce greater linear travel with each revolution of the rod thereby reducing the time required to tighten the clamp.

### TECHNICAL FIELD

The present disclosure relates generally to electrical safety equipment, and more particularly to grounding clamps and related equipment for safely performing testing and maintenance on power lines and electrical equipment such as transformers and relays.

BACKGROUND

Working to maintain and repair high voltage power lines such as the overhead lines which transmit electricity from generating stations to end users requires a number of tools and equipment to be performed safely. Grounding clamps and grounding clamp assemblies such as that shown in FIG. 1 have been used by line workers to safely ground overhead lines during maintenance procedures. Typically such grounding clamp assemblies 20 include one or more clamps 22, 24 operationally connected to a heavy gauge conducting wire 42 which may be coated in an insulating material. The grounding clamps 22, 24 in this particular example are shown as C-clamps, but other styles of clamps may also be used. Each clamp 22, 24 includes a body portion 26 having a fixed jaw 28 and a threaded receiver 44. A sliding or movable jaw 30 is operationally connected to a threaded rod 32 which is engaged with the threaded receiver 44 such that turning the threaded rod 32 moves the movable jaw 30 relative to the fixed jaw 28. The threaded rod 32 typically includes an attachment point 34, commonly a ring, which allows the threaded rod 32 to be operated at a distance by a user using a rod or hook extension. The heavy gauge conducting wire 42 is operationally (electrically) connected to a clamp 22, 24 at one or more ground connection points 36, 38 such as ring clamps, ferrules, or other suitable attachment means. Optionally, a non-conductive sheath 40 may be used to shield the conducting wire 42 where it is attached to the clamp 22, 24 for additional protection.

The fixed jaw 28 typically has a hook-like shape to enable the clamp to be hung on the overhead line to be grounded while the threaded rod 32 is operated to urge the movable jaw 30 towards the fixed jaw 28 until the overhead line is secured by the clamp 22, 24 between the jaws 28, 30. Once one clamp has secured the line to be grounded the other clamp may be secured to a grounding wire or a grounding rod as desired. Once the repairs or maintenance have been completed the clamps may be removed and the line brought back into service. This design for grounding clamp assemblies has been little changed since it was first developed so there is a need for an improved clamping system which allows for faster and safer grounding operations.

### SUMMARY OF THE INVENTION

In one aspect, a grounding clamp system is disclosed which includes a grounding clamp having a fixed clamping member and a threaded receiving portion. The grounding clamp system further includes a multi-start threaded rod (such as a double start threaded rod) passing therethrough the threaded receiving portion and is connected to a movable clamping member such that rotation of the threaded rod selectively moves the movable clamping member relative to the fixed clamping member. In some examples, the frame of the grounding clamp has a uniform composition free of welds, brazing, and the like and may be composed of aluminum, steel, or brass. The clamp may include one or more ground connecting points on the grounding clamp frame capable of connecting a grounding cable to the grounding clamp in electrical continuity. The threaded rod may further include a coupling feature such as a ring for allowing the threaded rod to be rotated using a suitable tool.

In another aspect, a method of using a grounding clamp system is disclosed where a grounding clamp is provided having a frame with a fixed clamping member and a threaded receiving portion, a multi-start threaded rod (such as a double start threaded rod) passing through the threaded receiving portion and connected to a movable clamping member such that rotation of the threaded rod selectively moves the movable clamping member relative to the fixed clamping member, and a capture space disposed between the fixed clamping member and the movable clamping member. The grounding clamp is deployed with the movable clamping member adjacent to the threaded receiving portion such that a conductor to be grounded is disposed within the capture space. The threaded rod is then rotated either by hand or using a tool to move the movable clamping member towards the fixed clamping member so as to secure the conductor between the movable clamping member and the fixed clamping member. In one example the rotating step requires fewer than 6 full rotations of the threaded rod when the movable clamping member begins adjacent to the threaded receiving portion to secure the conductor. In another example, the rotating step requires fewer rotations of the threaded rod when the movable clamping member begins adjacent to the threaded receiving portion to secure the conductor than a single start thread requires. In yet another example the threaded rod has a pitch relative to a lead of at least 1:2.

In still another aspect, a kit for a grounding clamp system is disclosed where the kit includes at least one grounding clamp set having a first grounding clamp having a frame with a fixed clamping member, a threaded receiving portion, and a multi-start threaded rod passing through the threaded receiving portion and connected to a movable clamping member such that rotation of the threaded rod selectively moves the movable clamping member relative to the fixed clamping member, a second grounding clamp having a frame with a fixed clamping member, a threaded receiving portion, and a multi-start threaded rod passing through the threaded receiving portion and connected to a movable clamping member such that rotation of the threaded rod selectively moves the movable clamping member relative to the fixed clamping member, and a conducting cable connected at a first end to the first grounding clamp and at a second end to the second grounding clamp such that the first grounding clamp and the second grounding clamp are in electrical communication. The kit may further include a ground lifting tool having at least one end configured to engage with and rotate the threaded rods of the first grounding clamp and the second grounding clamp. The kit may also further include one or more of a grounding stake and an insulated conducing cable.

### BRIEF DESCRIPTION OF THE DRAWINGS

FIG. 1 is a grounding clamp apparatus according to the prior art;

FIG. 2 is an improved grounding clamp according to one embodiment;

FIG. 3 is a side view of the clamp shown in FIG. 2 clamping a conductor;

FIG. 4 is a side view of a portion of a threaded rod as used in one embodiment;

FIG. 5 is a partially cut away view of a frame according to one embodiment;

FIG. 6 is a side view of a clamp according to one embodiment in the opened position;

FIG. 7 is a side view of the clamp shown in FIG. 6 in the opened position; and

FIG. 8 is a kit including clamps according to one embodiment.

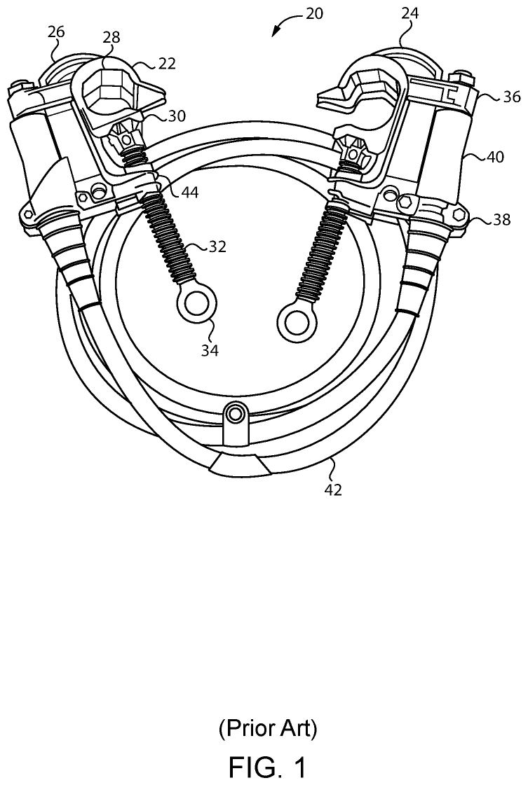

### DETAILED DESCRIPTION

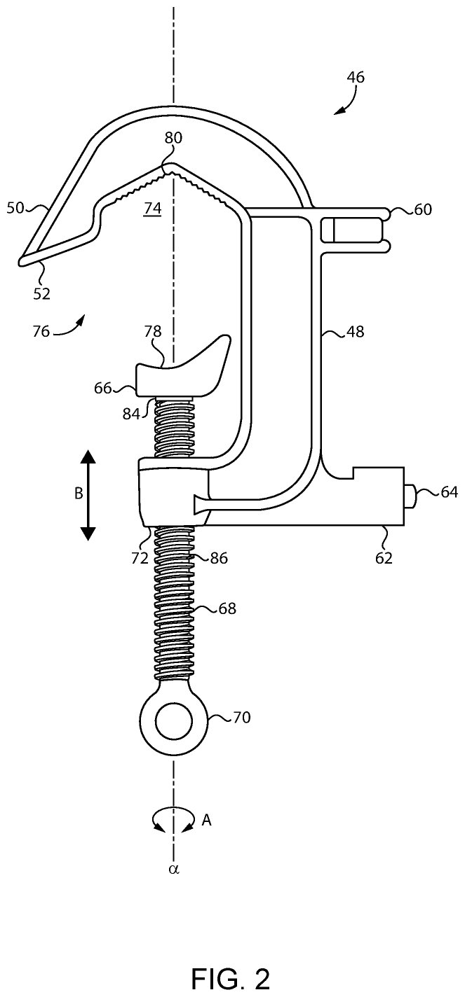

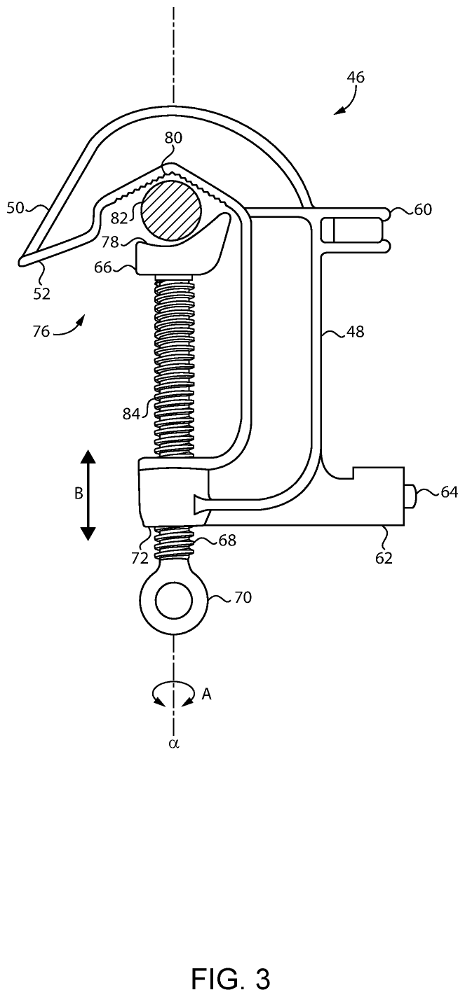

Referring to FIGS. 2-3, there is shown an improved grounding clamp 46 according to one embodiment of the present disclosure. The grounding clamp 46 includes a frame 48 having an upper/fixed clamping member 50 having a securing surface 80 and capture feature or portion 52. The capture portion 52 in this example is a hook-like structure or finger which is sized and configured to allow for the clamp 46 to more easily be guided onto the conductor 82 which will be described in greater detail below. The frame 48 further includes at least one ground connection point 60, 62 for attaching a grounding cable (not shown) to the clamp 46. The connection point(s) may be a ferrule-style connection 60, a clamp style connection 62 with one or more ground securing fasteners 64, or other suitable structure for attaching a grounding cable. The frame 48 also includes a threaded receiving portion 72 which has internal threads sized and configured to compliment the threads 86 on a threaded rod 68. The threaded rod 68 includes a coupling eye 70 sized and configured for coupling with the c-hook end of a ground lifting tool. In other embodiments, a coupling feature other than an eye may also be used such as a hook, clevis, or other feature designed to engage with a tool which may then impart rotational motion to the threaded rod. When coupled with the c-hook end of a ground lifting tool the threaded rod 68 may then be rotated in direction A about axis alpha (α). Rotation of threaded rod 68 is translated into linear movement of the rod 68 in direction B. Threaded rod 68 is cut such that it is what is known as a multi-start thread which will be discussed in greater detail below. Distal from the coupling eye 70 on the threaded rod 68 is a lower/movable clamping member 66. The threaded rod 68 is journaled in the movable clamping member 66, optionally with a bearing 84. The movable clamping member 66 includes a securing surface 78. The securing surfaces 78, 80 are shaped and configured to receive and hold a conductor 82 in a capture space 74 defined by the frame 48 and the securing surfaces 78, 80 via an opening 76. Optionally, one or both of the securing surfaces 78, 80 may further include grooves, knurling, or other surface features which improved the grip of the securing surfaces 78, 80 on a conductor 82. The capture portion 52 in this example extends beyond securing surface 80 and the capture space 74 and curves back towards the threaded receiving portion 72 to form a hook-like structure. This configuration allows the grounding clamp 46 to more easily capture and/or hang from a conductor 82.

A portion of a multi start threaded rod 100 is shown in FIG. 4. In this particular example the threaded rod 100 is a double start thread, that is, it has two distinct, non-crossing, grooves or roots 102, 104 cut into the rod producing two distinct and non-crossing threads or crests 106, 108. Typically such threaded rods 100 are produced by cutting a first root 102 to a desired depth producing a first crest 106 such that the rod 100 has a minor diameter 114 (the diameter from the bottom of a root to the opposite side of the rod) and a major diameter 116 (the diameter from the top of a crest to the opposite side of the rod). Once the first root 102 has been cut a second root 104 is cut such that it runs parallel to and never crosses the first root 102. The second root 104 is typically cut such that it starts directly opposite the first root 102 on the face 118 of the rod 100. Clamps of the present disclosure using multi-start threaded rods other than double start rods (e.g., triple start, quadruple start, and the like) is also contemplated.

One advantage of using multi-start threads in the clamps of the present disclosure is that such thread configurations produce a higher lead per revolution of the rod than single start threaded rods while still having a relatively shallow root depth. The lead 110 of a threaded rod is the linear rod travel (e.g., shown as direction B in FIGS. 2-3) accomplished in a single revolution of the rod (e.g., shown as direction A in FIGS. 2-3). The pitch 112 is the distance between a point on a screw thread and the corresponding point on the next thread. In a single cut threaded rod the pitch and lead are equal. In multi-start threaded rods, the pitch of the thread is proportional to a fraction of the lead of the thread. For example, in a double start thread the pitch is ½ of lead. Multi-start thread configurations allow for faster linear travel of the threaded rod for each revolution of the rod.

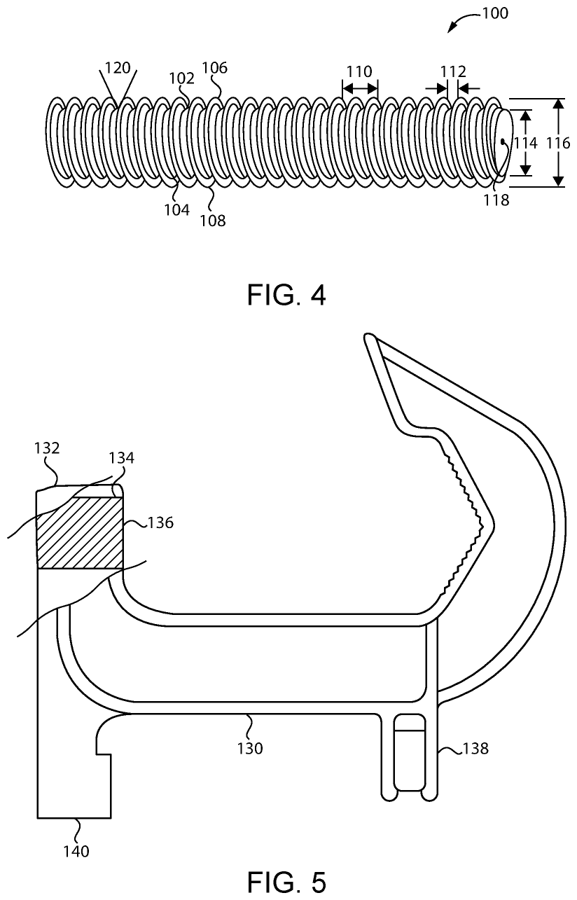

FIG. 5. Shows a partial cut away view of a clamp frame 130 according to one embodiment. The clamp frame 130 is typically cast as a single body of uniform composition (that is, free from welds, brazing, or similar fillers) from a suitable material such as aluminum, steel, brass, and the like. Features such as ground connection points 138, 140 may be later machined into the frame body 130. The threaded receiving portion 132 of the clamp frame 130 must include threads 136 corresponding to the threaded rod to be used with the finished clamp. That is, if a double start threaded rod is to be used then the threads 136 of the threaded receiving portion 132 must also be double start threads. The threads 136 may be formed by first drilling, boring, or otherwise forming a through passage 134 through the threaded receiving portion 132 having a diameter substantially equal to the final desired crest heights. Roots may then be cut into the through passage 134 to form the final threaded receiving portion 132 capable of threadably receiving the threaded rod to be used with the final clamp such as those previously described with respect to FIGS. 2-3.

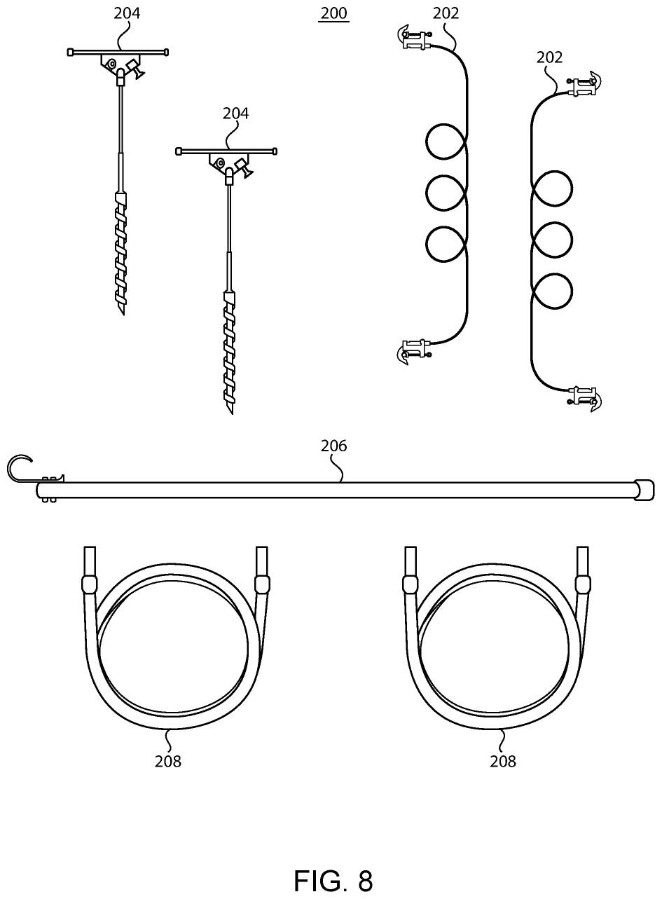

FIG. 8 shows example configurations for a kit 200 which includes one or more improved grounding clamps according to one or more of the embodiments described herein in addition to auxiliary equipment typically used to ground conductors such as power lines, cables, substations, and the like during repair and/or maintenance of such conductors. Such kits 200 may include one or more grounding sets 202 which are two improve grounding clamps as described herein operationally connected by an insulated conductive cable. Such kits may also include one or more grounding stakes or spikes 204 designed to be driven into the earth and having one or more attachment points where a grounding clamp may be attached thereto so as to ground a conductor to earth. The kits 200 may further include a ground lifting tool or rod which is typically a pole made from fiberglass or some other non-conductive material with a c-hook or other lifting/manipulating tool at one end to allow for a user to hook lines, lift and operate clamps, and the like. Further, the kits 200 may also include one or more additional insulated conducting cables 208 such as those included in the grounding sets 202 as replacements for when such cables become worn or damaged.

### INDUSTRIAL APPLICABILITY

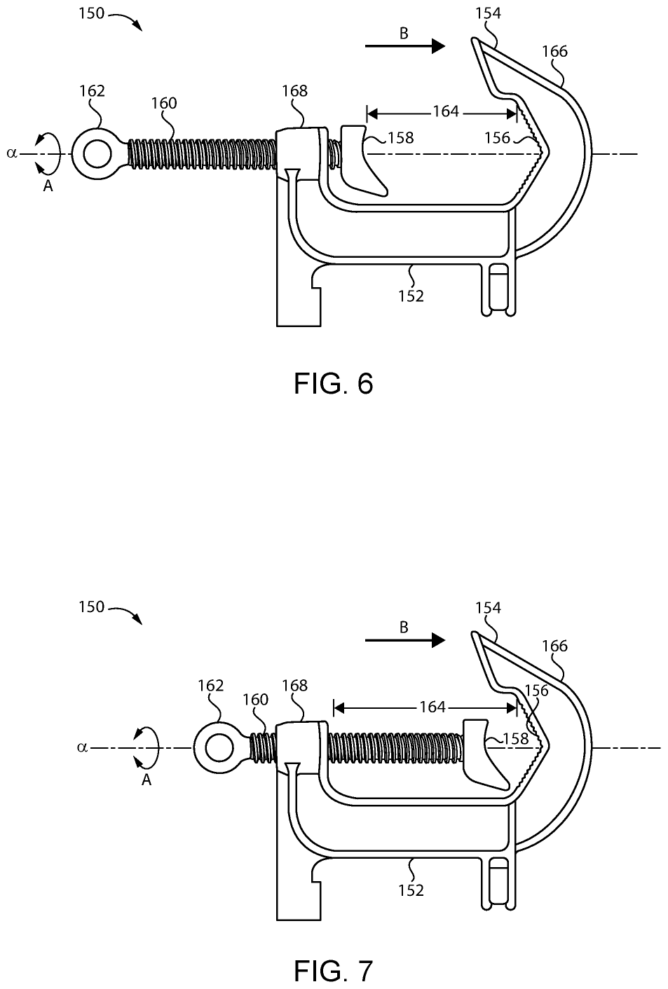

Referring to the drawings generally, but in particular now to FIGS. 6-7, there is shown a clamp 150 according to one embodiment. The clamp 150 has a frame body 152 with a capture portion 154, a fixed clamping member 166 having a securing surface 156, and a threaded receiving portion 168. Operationally engaged with and threaded through the threaded receiving portion 168 is a threaded rod 160 having double start threads as previously described. The threaded rod 160 has a coupling feature 162 (in this example an eye) at one end and a movable clamping member 158 distal from the coupling feature. When the threaded rod 160 is screwed out until the movable clamping member 158 is adjacent to and/or contacts the threaded receiving portion 168 the movable clamping member 158 is at a distance 164 from the securing surface 156 of the fixed clamping member 166 (FIG. 6). Imparting rotational motion in direction A to the threaded rod 160 by rotating the coupling feature 162 (either by hand or using a tool) generates linear travel to the movable clamping member 158 in direction B until the movable clamping member 158 is adjacent to and/or contacts the securing surface 156 of the fixed clamping member 166 (FIG. 6). The number of full rotations of threaded rod 160 needed to generate linear travel of the movable clamping member 158 distance 164 may vary from clamp to clamp, but will always be less than the number of full rotations required by a single start threaded rod in a similarly configured clamp. For example, a clamp configured such that distance 164 is 1.28 inches and a threaded rod diameter of ¾ inches having double start threads with a pitch of 6 would require no more than 3.84 full rotations to cause the movable clamping member 158 to travel distance 164. In another example, a clamp configured such that distance 164 is 2″ and a threaded rod diameter of ¾ inches having double start threads with a pitch of 6 would require no more than 6 rotations.

The use of multi-start threads on the threaded rod which drives the movable clamping member allows a user to close the clamp and secure it to a conductor which requires grounding more quickly (i.e., with fewer rotations of the threaded rod). Any maintenance or repair where high voltages are present is potentially dangerous. In many situations where such grounding clamps are used external factors such as wind, rain, snow, darkness, and the like make such instances even more dangerous. As such, securing and grounding a conductor as quickly as possible is especially advantageous. By using double start and other multi-start threaded rods the improved grounding clamps of the present disclosure allow for clamping and securing conductors more quickly than grounding clamps which use single start threads.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A grounding clamp system, comprising:
a grounding clamp having a frame with a fixed clamping member, a threaded receiving portion, and at least one ground connecting point; and
a threaded rod having multi-start threads and passing therethrough the threaded receiving portion and connected to a movable clamping member such that rotation of the threaded rod selectively moves the movable clamping member relative to the fixed clamping member;
wherein the ground connecting point is configured to connect a grounding cable to the grounding clamp in electrical continuity.

2. The grounding clamp system of claim 1 wherein the composition of the grounding clamp frame is uniform.

3. The grounding clamp system of claim 2 wherein the grounding clamp frame is made from one of aluminum, brass, or steel.

4. The grounding clamp system of claim 1, further comprising a capture portion.

5. The grounding clamp of claim 4, wherein the capture portion comprises a hook adjacent to the fixed clamping member.

6. The grounding clamp system of claim 1, further comprising a coupling feature on the threaded rod distal from the movable clamping member.

7. The grounding clamp system of claim 6 wherein the coupling feature is a ring.

8. The grounding clamp of claim 1 wherein the threaded rod is a double start thread.

9. The grounding clamp of claim 1 wherein the threaded rod has a pitch relative to a lead of at least 1:2.

10. A method of using a grounding clamp system, comprising:
providing a grounding clamp having:
a frame with a fixed clamping member, a threaded receiving portion, and at least one ground connecting point:
a multi-start threaded rod passing therethrough the threaded receiving portion and connected to a movable clamping member such that rotation of the threaded rod selectively moves the movable clamping member relative to the fixed clamping member:
a capture space disposed between the fixed clamping member and the movable clamping member;
deploying the grounding clamp with the movable clamping member adjacent to the threaded receiving portion such that a conductor to be grounded is disposed within the capture space: and
rotating the threaded rod to move the movable clamping member towards the fixed clamping member so as to secure the conductor between the movable clamping member and the fixed clamping member.

11. The method of claim 10 wherein the rotating step requires fewer than 6 full rotations of the threaded rod when the movable clamping member begins adjacent to the threaded receiving portion to secure the conductor.

12. The method of claim 10 wherein the rotating step requires fewer rotations of the threaded rod when the movable clamping member begins adjacent threaded receiving portion to secure the conductor than a single start thread requires.

13. The method of claim 10 wherein the threaded rod has a pitch relative to a lead of at least 1:2.

14. A kit for a grounding clamp system, comprising:
at least one grounding clamp set having:
a first grounding clamp having a frame with a fixed clamping member, a capture portion, a threaded receiving portion, and a multi-start threaded rod passing therethrough the threaded receiving portion and connected to a movable clamping member such that rotation of the threaded rod selectively moves the movable clamping member relative to the fixed clamping member;
a second grounding clamp having a frame with a fixed clamping member, a capture portion, a threaded receiving portion, and a multi-start threaded rod passing therethrough the threaded receiving portion and connected to a movable clamping member such that rotation of the threaded rod selectively moves the movable clamping member relative to the fixed clamping member; and
a conducting cable connected at a first end to the first grounding clamp and at a second end to the second grounding clamp such that the first grounding clamp and the second grounding clamp are in electrical communication.

15. The kit of claim 12, further comprising a ground lifting tool having at least one end configured to engage with and rotate the threaded rods of the first grounding clamp and the second grounding clamp.

16. The kit of claim 12, further comprising one or more of a grounding stake and an insulated conducing cable.
